(19) United States
(12) Patent Application Publication
(10) Pub. No.: US 2009/0100760 A1
(43) Pub. Date: Apr. 23, 2009

(54) SNAP FIT HANGING PANEL AND LOCKING APPARATUS THEREFORE

(76) Inventor: K. Bradley Ewing, North Vancouver (CA)

Correspondence Address: JOHN RUSSELL UREN, 1590 BELLEVUE AVENUE, SUITE 202, WEST VANCOUVER, BC, V7V1A7, CA

(21) Appl. No.: 12/175,676

(22) Filed: Jul. 18, 2008

Related U.S. Application Data
(63) Continuation-in-part of application No. 10/830,893, filed on Apr. 22, 2004.
(60) Provisional application No. 60/951,180, filed on Jul. 20, 2007.

(51) Int. Cl. E05D 15/06

(52) U.S. Cl. 49/410

(57) ABSTRACT

A hanging panel assembly utilises a core which is encompassed by a press fit material installed by the user generally without mechanical attachments. A series for further members are subsequently connected to the press fit material using a snap-lock type connection. A locking mechanism is used with the hanging panel assembly which utilises a longitudinal latch operated by a rotating handle. An interference member dictates whether the longitudinal member may be moved. A disabling assembly moves the interference member out of engagement and allows the door to be opened from the inside without the necessity of inserting a key into the lock.

### CROSS-REFERENCE TO RELATED APPLICATION

This is a continuation-in-part of U.S. application Ser. No. 10/830,893 filed Apr. 22, 2004 and claims priority from U.S. provisional application Ser. No. 60/951,180 filed Jul. 20, 2007.

### INTRODUCTION

This invention relates to a hanging panel assembly and to a locking mechanism for such a panel assembly and, more particularly, to a hanging panel assembly which allows an easy snap-fit type assembly configuration and to a locking assembly which facilitates locking of such panel assembly when movement is not desired.

### BACKGROUND OF THE INVENTION

Exterior sliding doors or panels which are opened and closed by sliding within a groove and which are maintained in their generally vertical position during the sliding movement are ubiquitous in residential and commercial construction. However, disadvantages in the use and installation of such panels are well known. First, if the sliding members are heavy, hanging such members is difficult and two or more specialized installers may be required. Second, continued and proper adjustment of the sliding panels is important for proper operation of the panels or doors and, again, skilled labor may not be readily available. Third, existing sliding members generally have their entire weight acting on bearings located on the bottom of the door which run on a rail. The rail is raised from the surface of the exterior and interior floors which causes access problems for carts and disabled users. The bearings, being on the bottom of the door, attract water and other debris which contacts the door and falls downwardly into the bearing area over time. The debris may enter the bearings, prohibit smooth movement of the doors and cause premature wear. In an effort to prevent this contamination, friction brushes are often used which, in turn, interfere with the smooth movement of the sliding members. Fourth, the weight of such doors may act in an unbalanced way on the bearings if they are not precisely positioned. Thus, one set of bearings may receive more loading than a second set of bearings which affects the operation of the doors and the bearing life. Finally, subsequent service to the sliding members after installation typically requires a number of service personal to raise the doors off their track for cleaning, item replacement and the like. Thereafter, the panel members will require installation and adjustment. This is unnecessarily expensive, time consuming and inconvenient for the user.

### SUMMARY OF THE INVENTION

According to one aspect of the invention, there is provided a hanging panel system having a core of metal material and a covering material extending about at least a portion of the perimeter of said core, said covering material having extending legs and a retaining member which cooperate with a first member to retain and maintain said first member adjacent said covering material, said first member having a snap-lock fit with said covering material.

According to a further aspect of the invention, there is provided a locking member for a hanging panel assembly having a longitudinal latch which engages and disengages with a sill assembly, a rotatable keyway for rotating an interference member into and out of operable contact with said longitudinal latch and a disabling member operable to move said interference member out of an operably contacting relationship with said longitudinal latch.

According to yet a further aspect of the invention, there is provided an adjustable sill sliding member mounted for adjustment within a fitting generally fixed to the bottom of a panel or door assembly, said sill sliding member being secured within said fitting by fasteners between said sill sliding member and said fitting and adjustable screw members mounted between said sill sliding member and said fitting to move said sill sliding member away from or towards said fitting throughout the length of said sill sliding member.

According to still yet a further aspect of the invention, there is provided a sill sliding member mounted for movement within a sill, said sill being mounted on or mounted within a guide support channel, said guide support channel being snap-fastened within a drain tube, said drain tube being snap fitted into a shoe, said guide support channel being reversible so as to allow said sill to be raised or lowered relative to the height of the surface within which said shoe is positioned.

According to yet a further aspect of the invention, there is provided a sill assembly installed in a structure with doors or panels moving above said sill assembly, the top of said sill assembly being flush with the finished surface of said structure wherein said sill assembly is installed, said doors or panels being sliding panels or doors, folding doors or panels or swinging doors or panels.

### BRIEF DESCRIPTION OF THE SEVERAL VIEWS OF THE DRAWINGS

Specific embodiments of the invention will now be described, by way of example only, with the use of drawings in which:

FIG. 1 is a diagrammatic isometric and cutaway view of two (2) adjacent sliding doors moving within adjacent drain tubes and which sliding doors incorporate the teachings of the present invention;

FIG. 2 is a diagrammatic end view of the sliding doors particularly showing the bearing mounting and the sill construction in which the sliding doors are guided according to a further aspect of the invention;

FIGS. 3A and 3B are partial diagrammatic front and side views, respectively, of a door panel according to a further aspect of the invention;

FIG. 4 is a diagrammatic sectional view taken along IV-IV of FIG. 3 but which further illustrates an adjacent door panel according to the invention;

FIG. 5 is a diagrammatic sectional view of a pair of door panels taken along IV-IV of FIG. 3 but particularly illustrating the pair of door panels at the bottom of the door panels;

FIG. 6 is a diagrammatic sectional view taken along VI-VI in FIG. 3 and which particular illustrates the vertical members of the door panel according to the invention;

FIG. 7 is a diagrammatic isometric view of the core of the hanging panel or door assembly with a covering material in place on the outside of the core in a further embodiment of the invention;

FIGS. 8A through 8H are diagrammatic enlarged and partially sectional views of the core and covering material and illustrating further and various members specific to the function of the hanging panel assembly;

FIG. 9 is a diagrammatic enlarged view of two hanging panel assemblies particularly illustrating the interlock jambs used between the hanging panel assemblies to prevent further movement;

FIGS. 10A-10C are diagrammatic front, side sectional and enlarged side sectional views, respectively, of the locking mechanism in its locked configuration according to a further aspect of the invention;

FIGS. 11A-11C are diagrammatic front, enlarged side sectional and side sectional views of the locking mechanism of FIGS. 10A-10C showing the locking mechanism in its disabled configuration;

FIGS. 12A-12E are diagrammatic isometric and partial sectional views of the locking mechanism particularly illustrating the rotating keyway and interference member; and

FIGS. 13A-13E are diagrammatic side views of the locking mechanism according to FIGS. 10A-10C but illustrating the condition of the locking mechanism in the unlocked, locked and disabled configurations, respectively.

### DESCRIPTION OF SPECIFIC EMBODIMENT

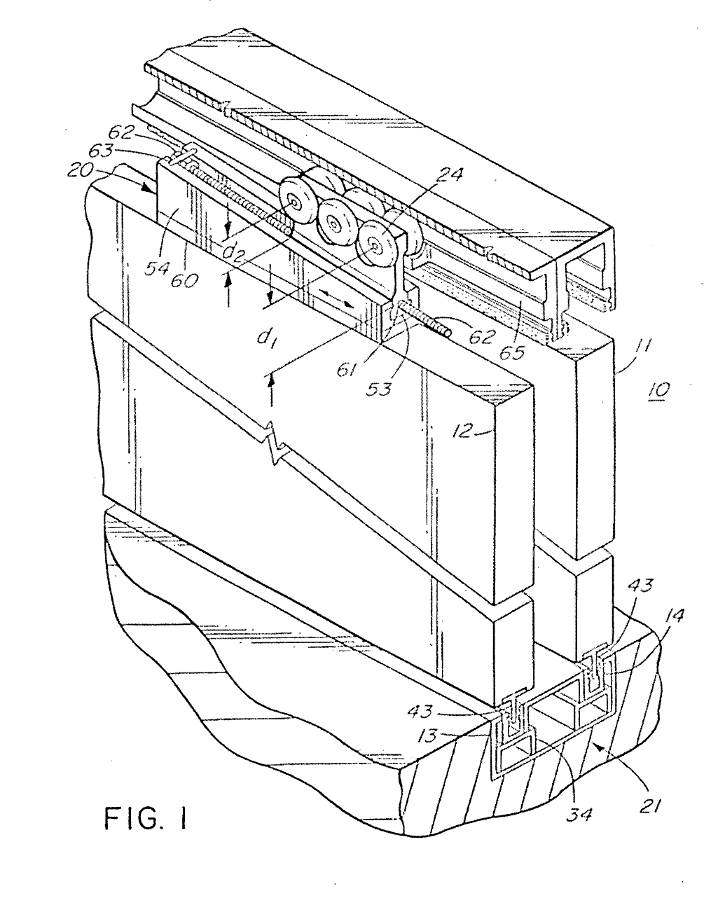

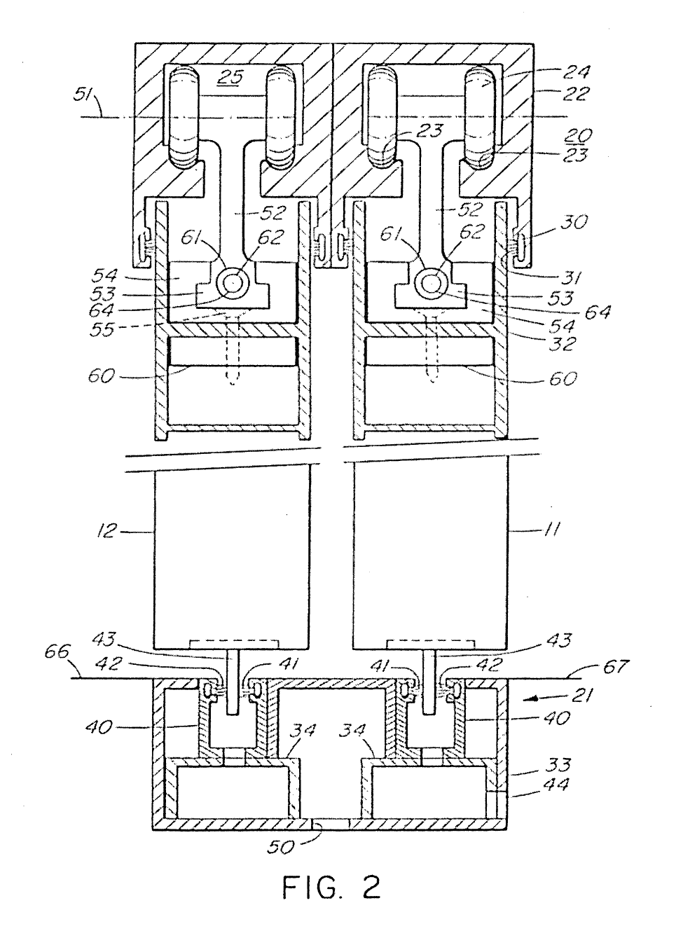

Referring now to the drawings, a set of sliding doors, in this case, two (2) such doors 11, 12 is generally shown at 10 in FIG. 1. The first and second doors 11, 12, respectively, move within respective guide strips 13, 14 and are each hung from a pair of upper hanging assemblies, one such hanging assembly being generally illustrated in detail at 20. A lower guide or sill assembly is generally illustrated at 21 in FIG. 2, it being understood that the upper hanging assemblies 20 and the lower guide or sill assembly 21 are the same for each of the sliding doors 11, 12.

A support bracket conveniently in the form of an aluminum extrusion 22 is mounted in the frame of the house or other structure (not shown). The support bracket 22 includes two (2) bearing guide paths 23 to allow the rotating bearings 24 of the bearing assembly 20 to move therein as will be described. The support bracket 22 also conveniently includes brush housings 30 which hold removable mohair brushes 31 used to provide a brushing action against the top frame member 32 of door 11 and thereby to prevent the ingress of water and debris and to remove loose foreign material from the door 11 during the sliding operation.

A second extrusion, conveniently a plastic drain tube 33, is similarly mounted in the frame of the house or other structure and forms the principal member of the sill assembly 21. The drain tube 33 contains side drain holes 44 and/or bottom drain holes 50 to allow the drainage of moisture and other debris to the outside environment. The drain tube 33 also allows for the entrance and retention of several shims or ribs 34. The shims 34 (FIG. 2) extend perpendicular to the longitudinal axis of the drain tube 33 and are relatively narrow. The shims 34 provide support for the guide strips 40 which are removably mounted on the shims 34 and within the drain tube 33. The guide strips 40 also contain brush housings 41 which allow the entry of removable mohair brushes 42. The brushes 42 bear on a guide or key 43 which is connected to the lower portion of the door 11 and which guide or key 43 provides a degree of stability during the sliding movement of the panel members 11, 12. The guide 43 extends substantially the entire length of the bottom of the door 11 and may take the form of a T-section which is bolted to the bottom of the door 11 at several different locations to ensure connection integrity. It will be noted that the upper surface of the drain tube 33 may conveniently be level with both the interior and exterior floor surfaces 66, 67 thereby allowing carts, wheelchairs and the like to easily move along the floor surfaces 66, 67 and over the top of the drain tube 66 without difficulty although the upper surface may also be raised or lowered relative to the floor surfaces if desired.

The bearing assembly 25 includes the rotatable bearings 24 which are conveniently heavy duty and made from a TEFLON material in order to reduce the friction between the bearings 24 and the bearing guide paths 23 when the bearings 24 are moving within the guide paths 23. The bearings 24 conveniently number three (3) and rotate about respective axes 51. Bearings 24 are connected on each side of a hanger 52 which extends downwardly and centrally between the bearings 24 thereby to reduce or eliminate any moment acting on the bearings 24 by the hanging members 11, 12 which are each connected to the hanger 52 as will be described.

Hanger 52 terminates in an enlarged female member 53 which is mounted for reciprocal and longitudinal movement within a wedge member 54. The hanger 52 extends downwardly from the forward most bearing 24 as viewed in FIG. 1 a distance “d1” which distance “d1” is longer than the distance “d2” from the rearward one of the bearings 24 as also seen in FIG. 1. The slope between the two distances d1, d2 matches the slope of a wedge member 54 in which the female member 53 moves. Wedge member 54 is connected to an anchor plate 60 (FIGS. 1 and 2) which anchor plate 60 is mounted to the top of the door 11 and which has bolts 55 extending there through. Wedge member 54 therefore moves with door 11 and anchor plate 60 and remains stationary relative to the door 11 and anchor plate 60.

A threaded hole 61 extends through the female member 53 of hanger 52 and a threaded bolt 62 is threadedly connected through hole 61. A socket 64 in the end of the threaded bolt 62 allows the entry of a complementary matching member on the end of a tool (not shown) which is used to rotate the bolt 62. The bolt 62 is held by a collar 63 mounted for stationary position within wedge member 54 which collar 63 allows the bolt 62 to rotate freely within the threaded hole 61 of wedge member 54 while not moving the bolt 62 longitudinally and thereby drawing the hanger assembly 25 along the wedge member 54 which, because of the connection between the wedge member 54 and anchor plate 60 to the door 11, allows the panel member or door 11 to be easily moved upwardly and downwardly relative to the door bearing assembly 25 and the support bracket 22 as the installation may require in order that the door 11 hangs cleanly and moves freely.

A recess 65 is provided in the support bracket or aluminum extrusion 22 at the end of the bracket 22 mounted in the frame of the moving panels 11, 12 (FIG. 1). It will be understood that a further and second recess 64 is provided at the opposite end of the support bracket 22 which is not illustrated in FIG. 1. The recess 65 is formed by cutting away material previously forming the bearing guide paths 23 formed on either side of the longitudinal axis of the bracket 22. By removing the guide path material to form the recess 65, the bearing assembly 25 is easily inserted into the support bracket 22 and the bearings 24 can then move freely on the bearing guide paths 23. To prevent the bearings 24 from moving into the recess 65 during sliding movement and operation of the door 11, the wedge member 54 and anchor plate 60 are mounted to the door 11 at a position where, with the door 11 in its limiting positions of movement within lower drain tube 33 and upper support bracket 22, the bearings 24 remain a distance away from the recess 65 thereby avoiding any unnecessary stress in the bearing guide paths 23 adjacent the recess 65 and thereby avoiding the recess 65 entirely.

### OPERATION

In operation, it will be assumed that the upper support bracket 22 and the lower drain tube 33 have been installed in the frame of the structure into which the sliding panel or door assembly 10 is to be installed and that it is now intended to install the panel or door assembly 10 (FIG. 1).

The anchor plates 60, one for each of the bearing assemblies 25, which bearing assemblies 25 are mounted at opposite ends of each panel or door 11, are mounted to the top of each of the doors 11, 12 as seen in FIG. 1 and the key member 43 is attached to the bottom of the doors 11, 12 again by bolting the key member 43 to the door 11. The wedge members 54 are then connected to the anchor plates 60 by bolts 71 extending into the anchor plates 60. One wedge member 54 is mounted to each of the anchor plates 60; that is, one anchor plate 60 and one wedge member 54 are mounted to each end of each door 11, 12.

The lower guide strips 40 will be placed into position within drain tube 33 and will rest on the shims 34, the shims 34 being placed perpendicular to the longitudinal axis of the drain tube 33 and spaced intermittently along its length.

The doors 11, 12 will then be manually moved into their general installation position by placing the key 43 on the bottom of the door 11 into the guide strip 40 and allowing the door 11 to remain substantially vertically in its resting position on the drain tube 33. The top of the door 11 will be inserted into and retained by the sides of the support bracket 22 to prevent the door 11 from moving sidewardly and falling from its temporary and upright position.

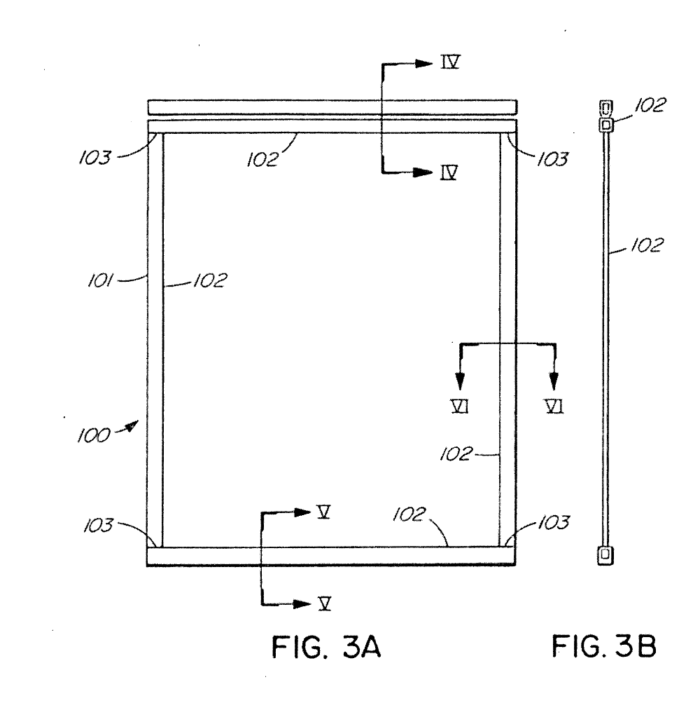

An installer will then begin the final hanging. The installer will insert a bearing assembly 25 into each of the wedge assemblies 54 by inserting the rotating bearings 24 into the guide paths 23 through the recess 64 (FIG. 1). He will then move the door 11 until the hanger 52 and male member 53 are aligned with the recess 72 in the wedge member 54 (FIG. 3A) and the bolt 62 is rotated with the installation tool (not shown) which rotates the bolt 62 through its end socket 64 until the wedge assembly is fully engaged. A similar procedure will take place between the second bearing assembly 25 and the second wedge member 54 at the opposite end of the door 11. The installer will then raise or lower the door 11 relative to the guide paths 23 by appropriately rotating the bolt 62 at each end of the door 11 so that the key 43 reciprocates freely within the guide strips 40 with the mohair brushes 42 suitably brushing the key 43 as the movement of the door 11 takes place and so that the door 11 is suitably level within the upper extrusion 22 and so that the vertical ends 73 of the door 11 match the vertical sides (not shown) of the door frame.

It will be appreciated that the bearings 24 act on either side of the longitudinal axis 70 of the upper support bracket 22 and that the door 11 hangs vertically from the hanger 52 which is connected to the bearings 24. Thus, the weight of the door 11 acts generally vertically downwardly and generates little if any moment on the bearings 24 and bearing assembly 25. The key 43 thereby also moves freely within the guide strips 40 and allows the mohair brushes 40 to brush debris and foreign material off the key 43 which debris is disposed of through the bottom and side drain holes 50, 44, respectively, in the drain tube 33. The key 43 also serves to block the egress of wind and water driven from the outside environment. Any such wind, water or debris will fall into the guide strips 40, thence to the guide tube 33 and out to the outside via drain tubes 44, 50.

The use of the wedge member 54 to move the door 11 upwards and downwards will allow a single installer to provide the finished door installation in which the door 11 may be centered and raised or lowered as necessary so the loading of the door 11 will fall on the bearings 24 of the bearing assembly 25 and so that the door 11 may be appropriated fitted within the door frame to provide a close matching fit with the door frame. The panel or door members 11, 12 may also be easily raised relative to the guide tube 33 by a user using the described tool to rotate bolt 62 and thereby raise the panel members 11, 12 relative to the guide tube 33. If the user intends to clean the guide tube 33 and drain tubes 40 of the sill assembly 21, it is convenient to do so without the necessity of removing the heavy door or panels 11, 12. All the members making up the sill assembly 21 can be easily replaced if necessary.

Many modifications will readily occur to those skilled in the art to which the invention relates. For example, the use of relative movement between the wedge member 54 and the bearing assembly 25 so as to lift and lower the door 11 relative to the extrusion 22 may suitably be modified by allowing the bearing assembly 25 to remain stationary relative to the door 11 and by moving the wedge member 54 relative to the door 11 and bearing assembly 25. All that is needed is relative movement between the bearing assembly 25 and the wedge member 54 in order to provide the necessary adjustment. Likewise, while it is apparent that the use of heavy sliding doors, used in exteriorly exposed position, will most often make use of the invention, it is intended to cover sliding panel members as well.

It is further contemplated that, of course, portions of the sill assembly can be raised if desired such that the sill assembly may project above the surfaces of the exterior and interior floors.

A further embodiment of the invention is illustrated in FIGS. 3-6 which collectively illustrate a thermal broken door panel system generally illustrated at 100. This door system 100 conveniently utilizes a steel core 101 which provides rigidity and strength against exterior wind-loading pressures and which steel core 101 is made possible because of the hanging door assembly described and illustrated herein. The steel core 101 extends around the circumference of the panel 100 as best seen in FIG. 3. The steel core 101 comprises four separate members 102 which are welded together at the end portions 103 to form a substantially continuous periphery of the door system 100. The steel core 101 can, of course, be varied depending on the structural loading requirements which may also be affected by environmental considerations such as exposure to wind.

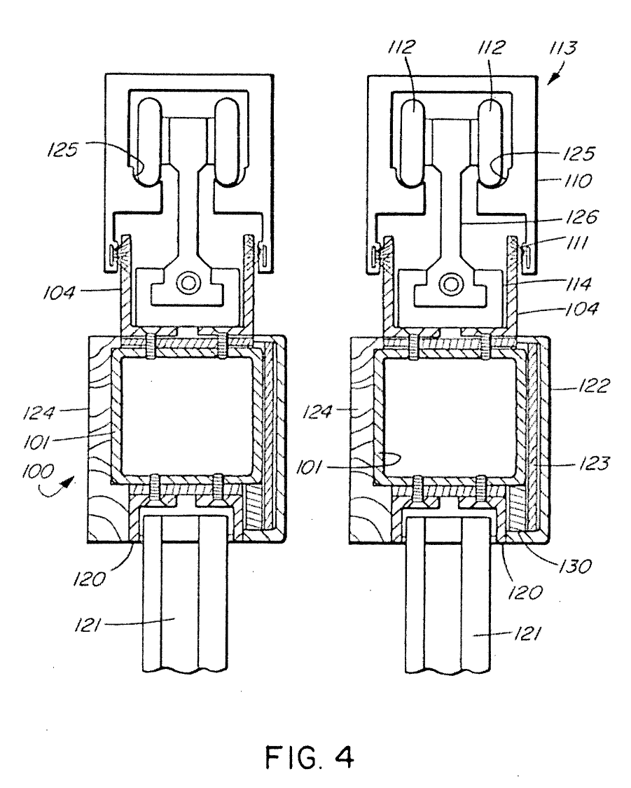

The top of each of the sliding door panels 100 is seen in detail in FIG. 4. A U-shaped bracket 104 is connected to the upper surface of steel core 101 as by bolts, screws or other known techniques. The U-shaped bracket 104 is designed to run within an aluminum extrusion 110 which is connected to the top of the door frame (not illustrated) and which includes mohair brushes 111 which brush the bracket 104 to maintain cleanliness within the extrusion 110 to keep contamination from entry therein. A hanging assembly generally illustrated at 113 includes a plurality of flexible wheels 112 run within the aluminum extrusion 110 which allow the panel systems 100 smooth movement relative to the aluminum extrusion 110. The hanging assembly 113 is connected to a further extrusion 114 which is fixedly mounted within the U-shaped bracket 104 with bolts or screws (not illustrated).

A further aluminum extrusion 120 is mounted beneath the steel core 101 as seen in FIG. 4. This extrusion 120 serves as the upper female member for receiving the upper or top of window 121.

An outside piece of clad aluminum material 122 is fitted to extend horizontally the length of the panel 100 and to cover the steel core 101. The clad aluminum material 122 is exposed to outside weather conditions and is therefore intended to be relatively robust in construction. An insulating member, conveniently made from LEXAN (Trademark) material 123, is positioned between the steel core 101, upper U-shaped bracket 104 and lower U-shaped extrusion 120. The insulating member 123 isolates the temperature of the clad aluminum material 122 from the steel core 101, the upper U-shaped bracket 104 and the bottom extrusion 120.

A preferred interior material, conveniently wood, granite, marble or other attractive material 124 is mounted directly to the steel core 101 and upper U-shaped bracket 104. Because of the thermal barrier in the form of the LEXAN spacer 123, the interior material 124 is isolated from the outside temperatures with the result that it is exposed to interior temperatures only and will not suffer from the exterior weather conditions which would otherwise dictate against it's use. Insulated filler material, conveniently laminated wood pieces 130 may be positioned between the LEXAN spacer 123 and the lower extrusion 120 and between the interior material 124 and the lower extrusion 120 as is illustrated.

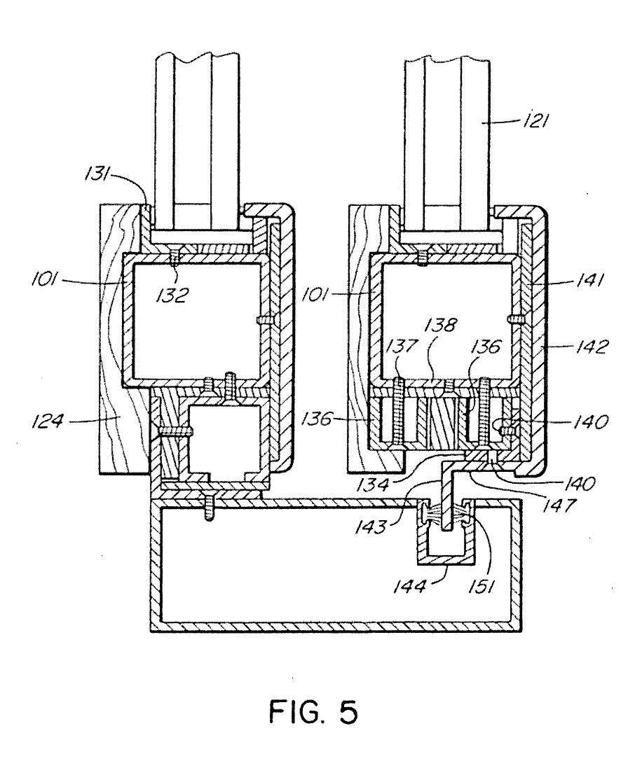

Referring now to FIG. 5, the assembly of the bottom of the panel system 100 is similar to that of the upper portion of the panel system described in relation to FIG. 4. The window 121 is fitted into a lower L-shaped extrusion 131 which is mounted to the steel core 101, conveniently with the use of bolts 132. The interior material 124 is likewise connected directly to the steel core 101, conveniently by gluing. An angle 134 is connected to the steel core 101 using screws 140 and a spacer made from LEXAN material 141 is positioned outside the angle 134 to serve the aforementioned insulating function. The aluminum exterior cladding 142 is formed so that a leg 143 extends into a continuous guide 144 which is positioned within the finished floor 150 of the structure in which the panel system 100 is to be installed. Mohair brushes 151 brush the leg 143 to prevent the ingress of contamination and to maintain the leg 143 in a generally vertical orientation. Insulating material, conveniently laminated wood 151, is positioned between the steel core 101 and the angle 134 with contact being made with the interior material 124 and further insulating material, likewise laminated wood 152 is positioned between the steel core 101 and the outside cladding 131 as is illustrated in FIG. 5.

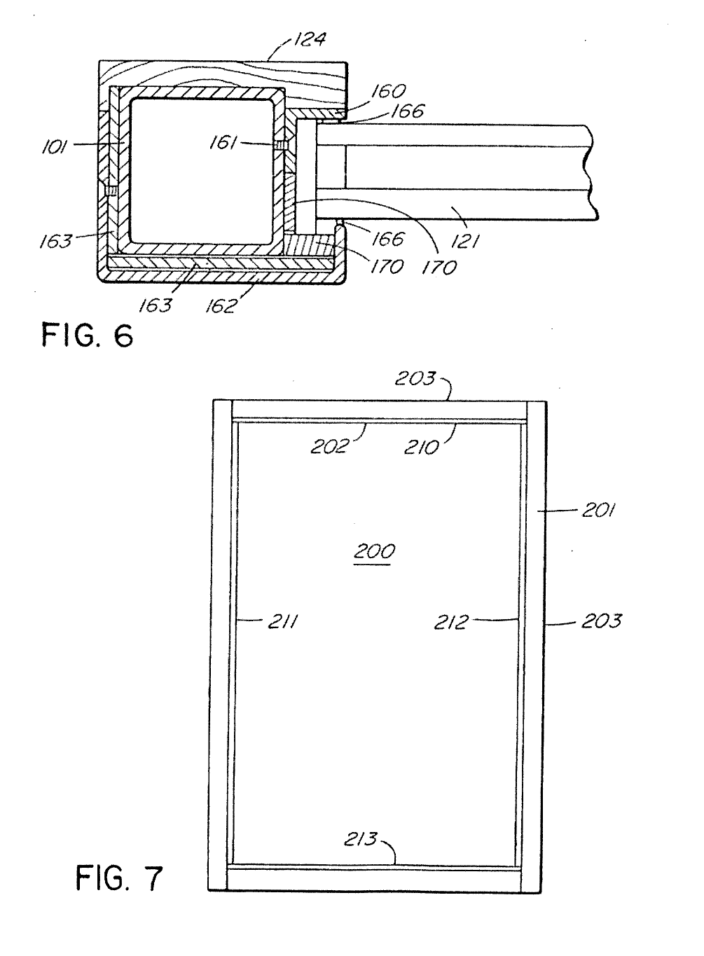

Referring now to FIG. 6, the vertical steel core 101 is shown with a similar construction to that described in association with FIGS. 4 and 5. A steel or aluminum extrusion 153 is mounted directly to the concrete wall 154 of the structure in which the panel system 100 is installed. Weather stripping is provided between the extrusion 153 and the panel system 100 since there is no movement of the panel system in FIG. 6 and it remains stationary relative to extrusion 153. The interior material 124 is mounted directly to the steel core 101 and an angle 160 is connected directly to the steel core 101 with the use of screws 161. Angle 160 accommodates the entry of the window 121. The outside cladding material 162 is formed to extend from the window 1321 to the interior material 124 and a LEXAN spacer 163 extends vertically in contact with the steel core 101 and laminate material 164 and between the steel core 101 and the outside classing 162 as is illustrated. Additional insulating material 170 may conveniently be positioned between the window 121 and the steel core 101 and the outside cladding 162 as is illustrated.

For ease of transport and handling, the welded steel cores 101 can be shipped and installed as skeleton frames. The thermal breaks or LEXAN insulating material described can be applied on-site since they are surface applied and the necessity for a crane to lift the material is obviated which is useful in sites which may be inaccessible to a crane or where weight considerations are important.

Various interior and exterior cladding options are likewise available since the interior and exterior cladding are thermally isolated from each other and despite the variation of thermal expansion of the different materials, such different materials may readily be utilized according to the desires of the user or designer. Similarly, although the system is particularly advantageous and has been described in association with windows, it is clear that the system is useful for non-window movable panels or a combination of solid wall panels as well as windows.

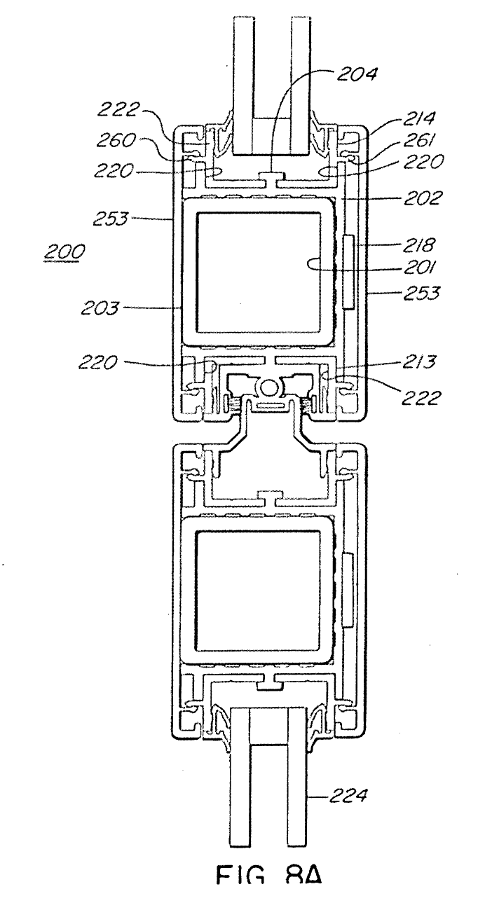

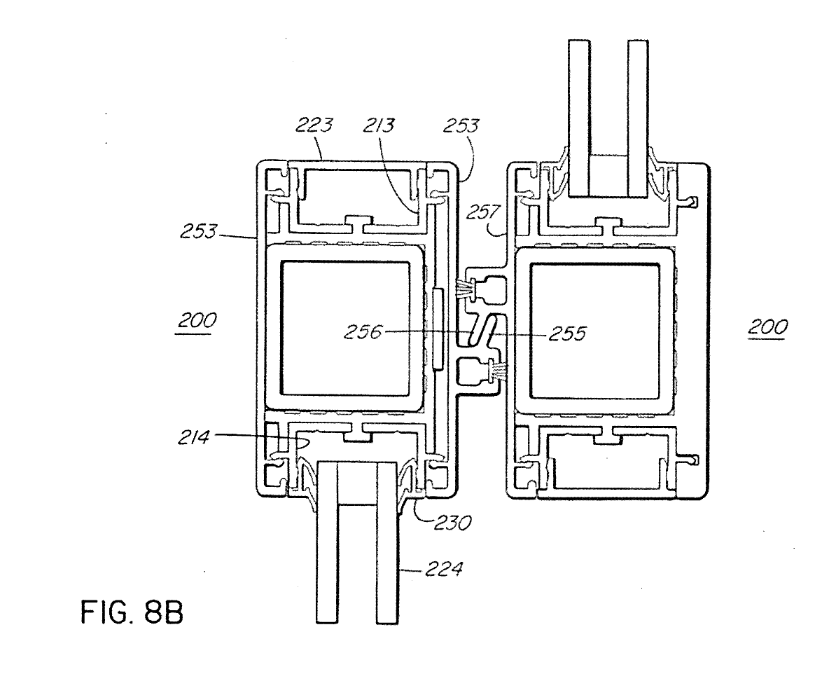

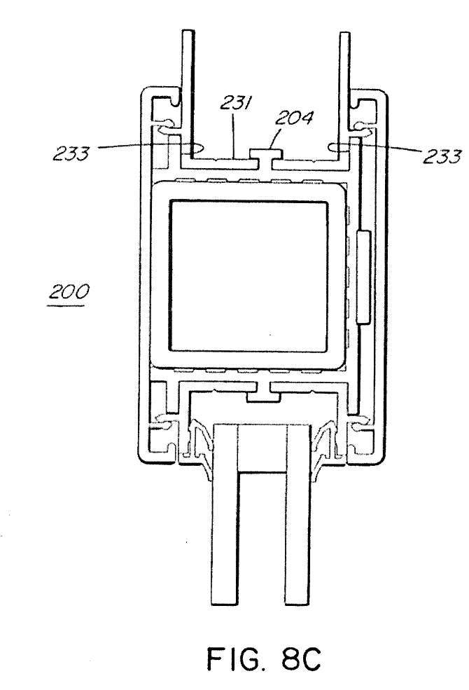

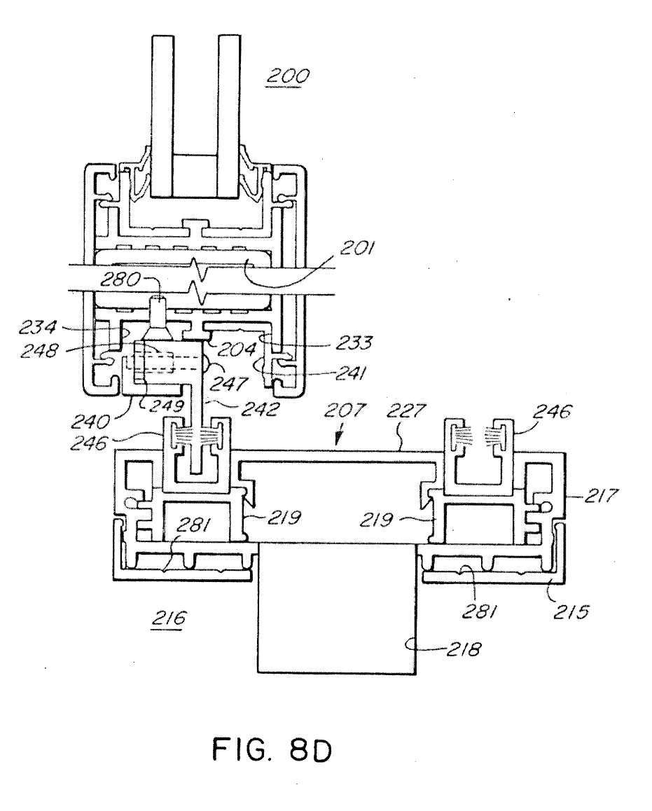

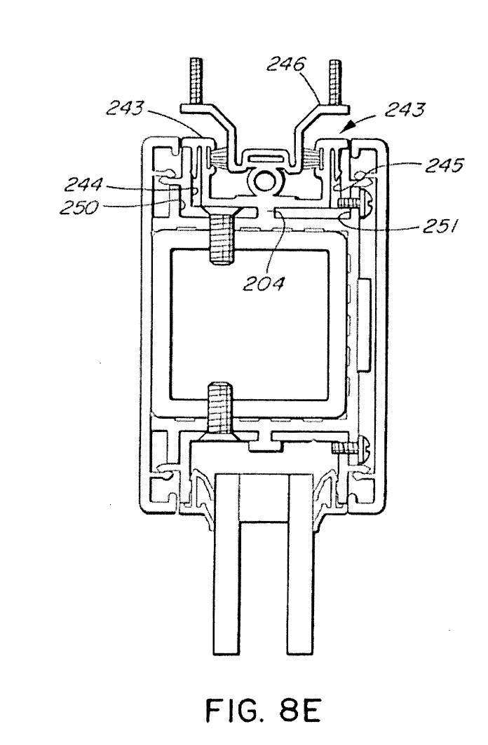

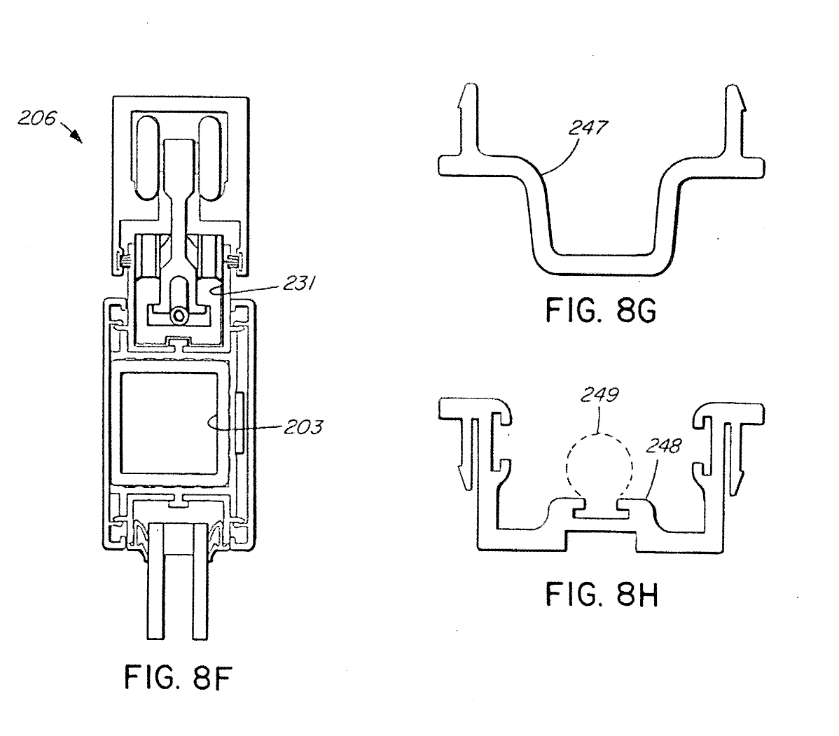

Yet a further embodiment of the invention is illustrated in FIGS. 7 and 8. In this embodiment of the invention, reference is initially made to FIG. 7 which diagrammatically illustrates the hanging panel assembly generally shown at 200. The hanging panel assembly 200 comprises a steel core 201 being generally square in cross-section (see FIG. 8A) which extends about the perimeter of the panel assembly 200. A piece of PVC material or fitting 202 is molded in a configuration which allows the PVC material 202 to be flexibly press fitted onto the steel core 201 on three sides with the outside surface 203 of the steel core 201 not being covered or encompassed by the PVC fitting 202 as described hereafter. There are four (4) pieces of PVC material 202 fitted to the steel core 201 with the closed side being positioned on the inside of the perimeter of the steel core 201. One or top piece 210 (FIG. 7) of PVC material is fitted to the top portion of the steel core 201. Second and third side pieces 211, 212 of PVC material are mounted to the sides of the hanging panel assembly 200. A bottom piece 213 of PVC material is likewise mounted on the bottom of the steel core 201.

Each of the pieces of PVC material has at least one T-shaped protuberance 204(FIG. 8A) which runs the length of each piece of PVC material which runs along and encompasses the steel core 201 as described. The T-shaped protrusions 204 and the corner extension pieces 220 allow for the retention of four (4) aluminum assembly fittings 213, 214, a pair of which are mounted on each side of the T-shaped protrusion 204 and which are simply fitted under the head lip of the T-shaped protrusion 204 and within the corresponding corner extension pieces 220. Each of the assembly fittings 213, 214 includes an external and longitudinal extension piece 222, the purpose of which will be explained in greater detail hereinafter.

The aluminum assembly fittings 213, 214 are adapted to receive various fittings depending upon the location and function of the fittings 213, 214. For example, the end of the panel 200 shown in FIG. 8B which extends generally vertically has a fitting 223 which is generally flat and which snaps fit with aluminum fitting 213. Likewise, where a window member 224 is to be held within the fitting 214 as also is shown in FIG. 8B, a member 230 is snap fitted into the fittings 213, 214 which allows the window 224 to be securely held.

FIG. 8B also illustrates the decorative cladding 253 which has a stop member 255 which engages with a corresponding stop member 256 on the decorative cladding 257 of the second door panel, which stops 255, 256 prevent further movement between the door panels in a first direction. In order to prevent further movement in the opposite direction, the cladding members 253, 257 may conveniently and simply be reversed in position without removal and re-installation of the heavy door panels 200. It will also be observed that because of the general reversibility features, the heavy panels 200 may be hung only and the decorative and functional fittings may be assembled on the doors or panels 200 sometime thereafter by simply adding the cladding and fittings when the final door or panel configuration and operating characteristics have been decided.

As seen in FIG. 8C, where the hanger assembly (not illustrated) is to be fitted to the top of the panel assembly 200, a fitting 231 is adapted to fit under the T-shaped protrusion 204 and within the vertical legs 233. This fitting allows for the holding of the hanger assembly 206 which is positioned within the fitting 231 (FIG. 8F).

As viewed in FIG. 8D, the fittings 240, 241 are adapted to fit within T-shaped protrusion 204 and vertical legs 233, 234. These fittings 240, 241 are adapted to allow the sill sliding member 242 to be accommodated within fitting 240 and for strengthening and integrity purposes, fitting 240 may be attached through fitting 233 and into steel core 201 by way of a screw 280.

It may sometimes be the case that the steel core 201 is not true and straight. If this is so, an adjustment is provided in the sill sliding member 242 relative to the fitting 240 which will generally follow the configuration of the steel core 201. A plurality of screws 247 intermittently located along the length of the sill sliding member 242 are threadedly engaged with and secure the sill sliding member 242 to fitting 240, as illustrated. In addition, a plurality of hex bolts 248 are likewise positioned intermittently along the length of the sill sliding member 242 and bear on the inside surface 249 of the fitting 240. By rotating the hex bolts 248 and by tightening and loosening the screws 247, the distance of the sill sliding member 242 from the inside surface 249 of the fitting 240 may be varied throughout the length of the fitting 240 so that the sill sliding member 242 runs true in the sill 246. It will also be observed that reversing the positions of the fittings 240, 241 will allow assembly of the sill sliding member 242 from either side of the panel assembly 200.

Again with reference to FIG. 8D, the sill assembly generally illustrated at 207 has a shoe 215 installed in the structure 216 with pane head screws (not illustrated). The shoe 215 is shimmed as necessary until it is level and straight about the drain 218. Small indentations 281 are formed in the shoe 215 which show the user where the pan head screws may be installed to secure the shoe 215 to the structure 216 in which the shoe 215 is mounted. Following the installation of the shoe 215, the drain tube 217 is positioned within the shoe 215. Holes may be cut at various locations in shoe 215 so that water accumulating within the shoe 215 moves to the drain 218 which in turn drains outwardly of the structure 216 as is known. The drain tube 217 allows guide support channels 219 to be fitted into the shoe 215 and the intermittent guide support channels 219 are snap-fitted into the drain tube 217. The guide support channels 219 are reversible if the height of the sill 207 needs to be varied so that the sill 207 and, more particularly, the sill guides 246 are threshold free and flush with the finished floor surface of the structure 216 within which the sill 207 is installed. The continuous sill guides 246 are then mounted on or in the guide channels 219 and the continuous sill member 227 is then snap fitted into contact with the channels 219 and guides 246. The sill assembly 207 is then complete.

Reference is made to FIG. 8E where the receiving jamb is generally illustrated at 243. The fittings 244, 245 are again adapted to fit within the T-shaped protrusion 204 and the legs 250, 251 of the PVC material. The additional receiving jamb 243 is adapted to snap fit into the fittings 244, 245. In an alternative embodiment relating to the male and female jambs 243, 246, the end receiving jamb 246 may be replaced with the end receiving jamb 247 as illustrated in FIG. 8G. Receiving jamb 247 is advantageous because it can be snap-fitted into the structure of the adjacent panel rather than being attached with screw or other mechanical connections. It is also easily replaceable in the event of wear or damage. If the receiving jamb 247 is to be used, a new fitting 248 (FIG. 8H) is also conveniently used as a replacement for fitting 243. Rubber or other flexible impact material 249 as shown in phantom in FIG. 8H is mounted within the groove 256 and acts to cushion impact between fitting 248 and receiving jamb 247.

Thus, it will be seen that around the circumference of the panel member 200, there is provided a PVC material 202 which surrounds three sides of the steel core 201 of the panel member 200 which allows the easy insertion and retention of aluminum and usually identical fittings which allow the further insertion of members which are specific to the function which is served by the particular portion of the panel 200 of interest; that is, the sides, the top and the bottom. All of the assembly of the aluminum fittings to the PVC material is done without threaded attachment screws or bolts although they certainly may be used where additional reinforcement or strength is deemed necessary.

Following the assembly of the fittings to the PVC material 202 and the installation of the window 224 (FIG. 8B) if desired, the hanger assembly 206 (FIG. 8F) and the sill assembly generally shown at 207 in FIG. 8D, the door jamb 243 as shown in FIG. 8E, the hanging panel assembly 200 may remain in its partially completed configuration without the attachment of the decorative cladding 253 (FIG. 8B) which completes the assembly.

This is done for several reasons. It is frequently the case that a structure under construction needs to be closed in as soon as possible due to inclement weather interfering with construction of the structure. While the structure itself may be then enclosed, the decorative aspects of the interior and exterior may be decisions to be made that are months away. Similarly, if the decorative panels 253 are installed on the panel 200 when the panel 200 is initially installed, they are subject to abuse and damage due to the ensuing construction of the structure in which building materials and tools may impact the final decorative cladding 253.

Following the completion of the structure or when the decorative aspects of the construction are ready for consideration, the decorative panels 253 may then be installed. Reference is made to FIG. 8A where the panel members 253 are installed on the fitting 214 by way of a press connection over the protruding legs 260, 261. In this embodiment, it will be clear that the inside cladding 253 is insulated by member 213 and is removed from the steel core 203 so cladding 253 is warm or at close to room temperature to the touch. The outside cladding 253 may contact the steel core 201 or preferably, a membrane (not illustrated) is installed between the cladding 253 and the steel core 203. The inside decorative cladding 253 may be one of several materials as desired by the owner, for example, wood, steel, aluminum, or composite material and it need not have weather resistant properties. In contradistinction, the outside panel 254 being exposed to outside conditions, will have properties that are conductive to weather resistance such as aluminum.

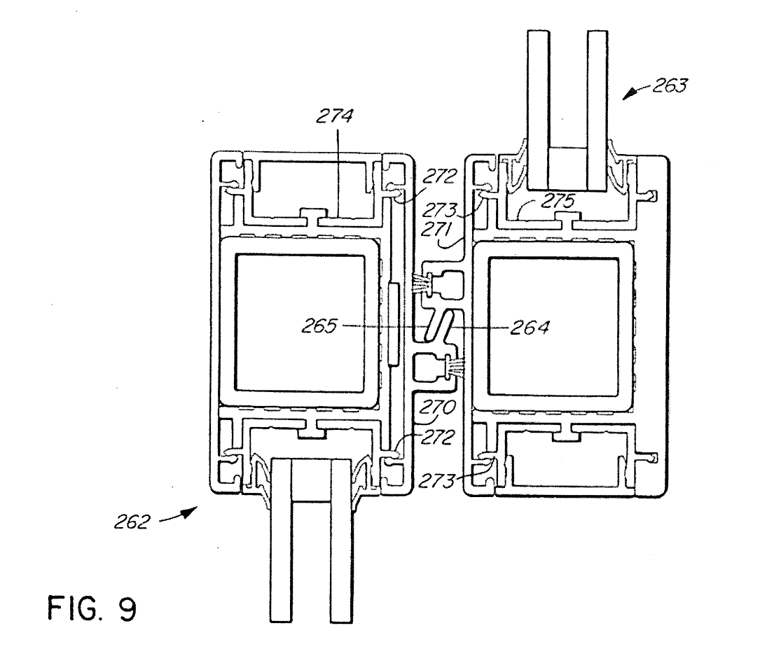

Reference is now made to FIG. 9 which illustrates first and second sliding panel or door members generally illustrated at 262, 263. Each of the sliding panel or door members 262, 263 include respective interlock members 264, 265 which are intended to make contact and prevent further relative movement between the two panels 262, 263 when they make contact on the insides of the sliding panels 262, 263. The interlock members 264, 265 are conveniently incorporated into the cladding 270, 271 which snap onto the extending legs 272, 273 of the fittings 274, 275.

Thus, the components described fit together in a snap lock type configuration rather than being mounted to the steel core or frame 201, 203 with mechanical fittings which allows efficient assembly and less expertise required on behalf of the installers. In addition, since the materials used may be different, the coefficients of expansion may likewise be different. The use of mechanical fasteners or adhesive can, over time, build up fatigue and stress since relative movement between the various materials may be prohibited by such use. This snap fit installation removes this problem since relative movement between the different materials is allowed.

Reference is now made to the locking mechanism generally illustrated at 300 in FIG. 10A. The locking mechanism 300 consists of four (4) principal apparatuses, namely the longitudinal latch 301, the rotating knob handle 302 which moves the longitudinal latch 301 vertically into and out of engagement with the sill (not shown), the lock disabling member 303 and the key lock 304 (FIG. 10C) which is disabled by the disabling member 303.

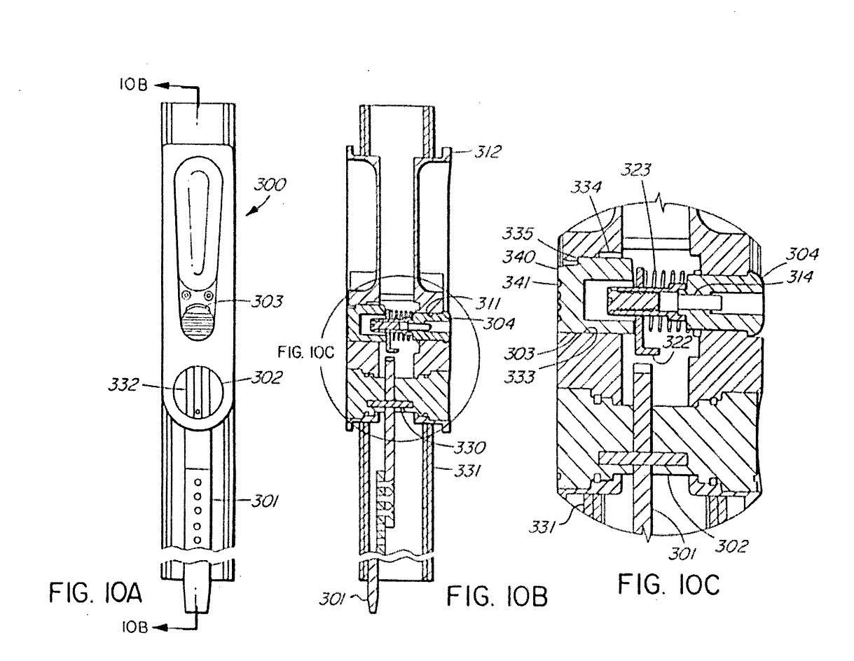

The key lock 304 and the disabling member 303 are best seen in an isometric view in FIGS. 12A-12E. The key lock 304 has a flat 310 (FIG. 12A) which matches a corresponding flat 311 in the door handle 312 (FIG. 10B) which maintains the circumference of the key lock 304 is a stationary position within the door handle 312. The key lock 304 rotates within the circumference and has a keyway 313 (FIG. 12A) which is rotated by the insertion of a key (not illustrated).

The keyway 313 is connected to a shaft 314 (FIG. 10C) which rotates with keyway 313. Shaft 314 extends from the keyway 313 to a position within a circumference 320 (FIG. 12C) of disabling member 303 but the end of which is positioned a distance from the end 321 of the internal circumferential cavity 320 so as to allow for movement of the disabling member 303 relative to the shaft 314 as will be explained. An L-shaped collar 322 is mounted on a flat of shaft 314. The flat (not illustrated) dictates that the collar 322 moves circumferentially with the keyway 313 when the keyway 313 is rotated but which flat also allows the collar 322 to move longitudinally relative to shaft 314. A spring 323 is mounted between a nut 324 mounted on the end of the keylock 304 and the collar 322 which spring 323 provides compression force on the collar 322 and maintains it in contact with the disabling member 303.

The rotating handle 302 is connected to longitudinal latch 301 by a pin 330 (FIG. 10B) which extends through the longitudinal latch 301, which rotates with handle 302 and which moves within a complementary and horizontally extending slot (not illustrated) in longitudinal latch 301. Thus, as the rotating handle 302 is rotated, pin 330 acts on longitudinal latch 301 to lift the latch 301 out of engagement with the bottom sill (not illustrated) within which the panel 331 moves and which extends the latch 301 into engagement with the sill. The rotating handle 302 also includes an attached and protruding longitudinal member 332 which is easily grasped by the fingers of a user and which allows easy rotation when so grasped from either side of the door or panel 331.

The disabling member 303 is conveniently made from aluminum. It is mounted within a corresponding recess 333 in door 331 (FIG. 10C) and has a series of ribs 341 which allow good traction and contact between the finger or thumb of a user and the disabling member 303. Disabling member 303 is maintained in contact with the L-shaped collar 322 by the compressive force of spring 323. The disabling member 303 is maintained within its recess 333 by two lands 334, 335 which each are complementary to a land 340 on the disabling member 303.

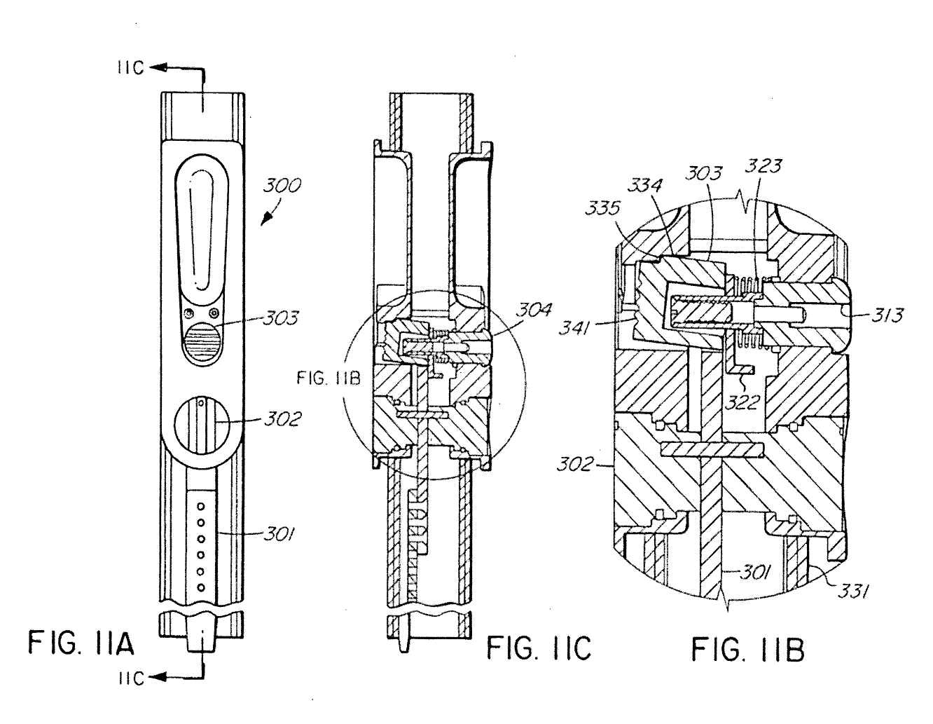

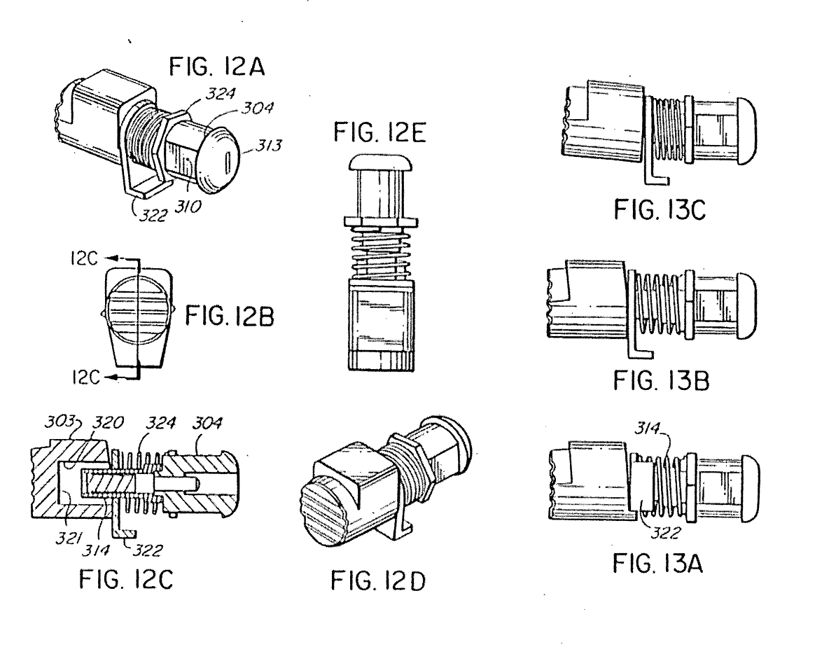

In operation, it will first be assumed that the locking mechanism 300 is in the unlocked position as is illustrated diagrammatically in FIG. 13A with the L-shaped collar 322 generally extending horizontally from the shaft 314. In such a position, the longitudinal latch 301 will be readily moved by rotating knob member 302 to engage or disengage with the sill since the L-shaped collar 322 will offer no interference to such movement of the longitudinal latch 301.

If the user now desires to lock the door 331 so that movement in the sill is prohibited, a key (not shown) will be inserted in the keyway 313 (FIG. 12A) on the outside of the door 331 and the keyway 313 is then rotated. Such rotation will rotate L-shaped collar 322 downwardly through ninety degrees until the L-shaped collar 322 assumes the position shown in FIG. 13B. In this position, as seen in FIG. 10C, if the knob 302 is rotated from either side of the door 331, the longitudinal latch 301 will be unable to move upwardly out of engagement with the sill because of contact being made between the top of latch 301 and the L-shaped collar 322.

Safety and statutory provisions dictate that the door 331 must be configured so as to open from the inside in the event of fire or other adverse event within the structure where the door 331 is located. If the user desires to open the door 331 from the inside, pressure will be applied inwardly on disabling member 303 (FIG. 11B) by contact between the fingers of a user and the ribs 341 of the disabling member 303. Such contact and inwardly directed force on the disabling member 303 will move the disabling member 303 rightwardly against the force of spring 323 and will likewise move the L-shaped collar 322 rightwardly against the spring force of spring 323.

The land 335 on disabling member 303 will move into contact with land 334 of the door handle 312 and remain in an inwardly located configuration as best seen in FIG. 11B. In this configuration, the L-shaped collar 322 is located rightwardly of the longitudinal latch 301 and offers no resistance or interference to vertical movement of the latch 301 when the rotating handle 302 is rotated to unlock the longitudinal latch 301 and remove it from the sill so as to allow the panel or door 331 to slide or move relative to the sill. Thus, the door 301 may be unlocked from inside the structure without the necessity of rotating the keyway 313.

To reinstate the locked position, the disabling member 303 is moved downwardly with reference to FIG. 11B. The longitudinal latch 301 is moved downwardly into its locked position by the rotation of handle 302 and the force from spring 323 will move the disabling member 303 back into its initial position as best seen in FIG. 10C. The L-shaped collar 322 will similarly move leftwardly. In such a position, it will offer interference to any movement of the longitudinal latch 301. Thus, the door 331 will be returned to its locked condition.

Thus, it will be seen that the locking mechanism 300 may be locked or unlocked by a simple rotation of the key lock 304 together with the L-shaped collar 322. More specifically, the longitudinal latch 301 is not connected to the L-shaped collar 322 so that the locking and unlocking actions move a minimal number and mass of mechanisms. This reduces the unlocking force required and electrical locking and unlocking would be quite convenient with a small solenoid used to rotate the key lock 304 and L-shaped collar 322. And a remote locking transmitter (not illustrated) could also convenient be used to wirelessly command the solenoid to rotate and unlock the door.

Many modifications will readily occur to those skilled in the art to which the invention relates. For example, the disabling member 303 while being disclosed as being of a resilient material offering good contact with the fingers of a user, could take various configurations and conditions to provide the rightwardly directed movement on the L-shaped collar 322 which will move the collar 332 out of its interference position with the longitudinal latch 301.

In addition, while the sill 207 and sill guides 246 have been disclosed as being flush with the finished structure surface within which the shoe 215 and sill 207 is positioned, particularly in association with sliding panels or doors as described, it is further contemplated that these teachings would be equally applicable with swinging and folding doors or panels as well.

Many further modifications will readily occur to those skilled in the art to which the invention relates and the particular embodiments herein described should be taken as illustrative of the invention only and not as limiting its scope as defined in accordance with the accompanying claims.

We claim:

1. A hanging panel system having a core of metal material and a covering material extending about at least a portion of the perimeter of said core, said covering material having extending legs and a retaining member which cooperate with a first member to retain and maintain said first member adjacent said covering material, said first member having a snap-lock fit with said covering material.

2. A locking member for a hanging panel assembly having a longitudinal latch which engages and disengages with a sill assembly, a rotatable keyway for rotating an interference member into and out of operable contact with said longitudinal latch and a disabling member operable to move said interference member out of an operably contacting relationship with said longitudinal latch.

3. An adjustable sill sliding member mounted for adjustment within a fitting generally fixed to the bottom of a panel or door assembly, said sill sliding member being secured within said fitting by fasteners between said sill sliding member and said fitting and adjustable screw members mounted between said sill sliding member and said fitting to move said sill sliding member away from or towards said fitting throughout the length of said sill sliding member.

4. A sill sliding member mounted for movement within a sill, said sill being mounted on or mounted within a guide support channel, said guide support channel being snap-fastened within a drain tube, said drain tube being snap fitted into a shoe, said guide support channel being reversible so as to allow said sill to be raised or lowered relative to the height of the finished surface within which said shoe is positioned, the top of said sill and/or said sill guides being flush with said finished surface of a structure within which said shoe and sill is mounted.

5. A sill assembly installed in a structure with doors or panels moving above said sill assembly, the top of said sill assembly being flush with the finished surface of said structure wherein said sill assembly is installed, said doors or panels being sliding panels or doors, folding doors or panels or swinging doors or panels.
